(19) United States
(12) Patent Application Publication
(10) Pub. No.: US 2025/0099793 A1
(43) Pub. Date: Mar. 27, 2025

(54) Vacuum Extinguisher

(71) Applicant: Chance Warren Wallace, Gig Harbor, WA (US)

(72) Inventor: Chance Warren Wallace, Gig Harbor, WA (US)

(21) Appl. No.: 18/371,446

(22) Filed: Sep. 22, 2023

(51) Int. Cl. A62C 25/00; A24F 13/18; A62C 99/00

(52) U.S. Cl. CPC A62C 25/00; A24F 13/18; A62C 99/0009

(57) ABSTRACT

A Vacuum Extinguisher comprising a tube, a hinge, a housing connected to said hinge and said hinge are removably connected to said tube, wherein said tube is removable, a battery, a pump, a controller, and a button. The pump is powered by the battery and generates vacuum in the tube when activated by the button.

### FIELD OF THE INVENTION

The field of personal recreational smoking extinguishers, containers and the like.

### CROSS REFERENCE TO RELATED APPLICATIONS

This application is not related to any U.S. application.

### REFERENCE REGARDING FEDERALLY SPONSORED RESEARCH OR DEVELOPMENT

Not Applicable to this invention.

### BACKGROUND

Currently in the field of personal recreational smoking there exists a strong need for a simple, inexpensive, and reliable method for extinguishing cigarettes, joints, or cigars and the like (collectively the “rolls”) that extinguishes the rolls without damaging it so that it can be relit later.

For many years inventors have tried to create a reliable method without success. Because no ideal existed previously, smokers typically extinguish the roll and discard it. If the roll is not discarded, then the smoker will have typically extinguished the roll physically, by grinding it on a surface or with their fingers, then saving the remainder. This process is less than ideal because the roll is likely to be damaged, some the smokable material is lost, and the smoker can injure themselves or damage the surface used to extinguish the roll.

For example, cigar or cigarette savers are metal cases into which a cigar is placed while smoldering and then closed. After the oxygen in the case is consumed the cigar stops combusting. In the process of burning out, more of the cigar is consumed, the smoke for the cigar may escape and the case can become hot to the touch. Thus, cigar savers are less than ideal for saving cigars or cigarettes for enjoyment later.

The below described new Vacuum Extinguisher was conceived and developed to overcome the limitations inherent in the above-described designs and processes.

### SUMMARY OF THE INVENTION

The Vacuum Extinguisher overcomes the above-described limitations by using a mixture of novel features. For example, the device quickly and efficiently extinguishes the flame on a roll by removing the oxygen supply from the burning end. In doing so, it provides a safe, effective, and discreet method for extinguishing joints without altering the taste or quality of the joint, making it reusable for later use, and also preventing the escape of any unwanted odors into the surrounding environment through the use of an air suction device that draws all the air out of the tube containing the roll. By creating an airtight seal around the joint the release of smoke and unpleasant odors into the surrounding environment is prevented and also reduces the amount of smoke and ash produced when extinguishing a roll.

The lifespan of the roll is also extended by preventing oxygen from reaching the burning end, which extinguishes the roll without leaving any residual ash or damage and allows it to be relit and enjoyed for a longer period of time.

Another feature is the elimination of the risk of burns or fire caused by improperly extinguishing a roll.

All of these features are provided in a compact and portable device that can be easily carried and used wherever needed and while on the go and improve the overall experience of smoking by providing a quick and convenient way to put out a roll with effortless operation that does not require the user to manually put out the flame.

In one embodiment, the Vacuum Extinguisher is comprised of an Air Suction Unit that creates a vacuum by removing air from the tube, which is used to extinguish the flame on the roll

A Tube serves as the container for the roll, and has one open end, one sealed end and an access port for a passageway connecting the Air Suction Unit to the Tube. The Tube should be airtight to allow for the vacuum to be created and maintained, but may allow for some air leakage, so long as sufficient vacuum is generated. An Activation Mechanism that triggers the Air Suction Unit to begin generating vacuum in the Tube. The Activation Mechanism can be a button, switch, or other mechanism that is easy for the user to activate. A Power Source to power the Air Suction Unit. The Power Source can be a battery, capacitor, or other power source that is compact and easy to recharge or change. A Control Circuit that controls the Activation Mechanism and Air Suction Unit and determines how fast the vacuum is generated. A Housing that serves as the exterior of the device and is designed to be durable and comfortable to hold, while also protecting the internal components of the device. The housing is designed to hold a tube for a roll and can be modified to accommodate different sizes and shapes of tubes for different types of rolls.

In one embodiment, the Air Suction Unit is further comprised of an Air Pump that generates vacuum in the Tube by pumping air out of it, an Air Filter that removes particulate matter or other contaminants from the air being removed from the tube, a Suction Hose that connects the Air Pump to the Tube, allowing air to be removed from it, and a Noise Suppressor that uses sound-deadening materials or mufflers to reduce the noise generated by the Air Pump.

In this and other embodiments, the Air Suction Unit is a micro air pump, designed to remove air from the tube and create a vacuum to extinguish the flame of a roll. The micro air pump is powered by the Power Source and is controlled by the Control Circuit. In addition, it is compact with a low noise level and low power consumption, and able to maintain a consistent vacuum for a sufficient period of time to effectively extinguish a roll. The Air Suction Unit has an air inlet which allows air to enter the unit from the tube where the roll is held and an air outlet that allows the air that has been removed from the tube to be exhausted to the outside of the air suction unit.

The Tube includes an access port allowing a tube, or other airtight passageway, access to the interior of the Tube, with the opposite end of the passageway attached to the vacuum intake of the Air Suction Unit.

In general, the vacuum tube does not directly penetrate the Tube. Instead, a gap is present between the Tube and the housing surrounding the Tube, with at least one end of the Tube open to the gap. The vacuum tube end is located in this gap and draws the air in Tube out through the gap using the Air Suction Unit.

In this and other embodiments, the Tube is detachable and may optionally include a Mouthpiece that allows the user to smoke a roll inside the Tube and the end of the Tube opposite the Mouthpiece includes an airtight seal to air from entering the tube when connected to the device.

When detached, the vacuum is maintained in the Tube via a Seal that covers the open end of the Tube and an Air Pump Access port valve that seals when detached from the Air Suction Unit.

During operation the Seal allows air to pass out of the Tube, but seals the Tube once the Tube is under vacuum. In one embodiment, the Seal operates by being made of a flexible material with two sides, that under normal pressure leaves a gap between the Tube and the Seal. However, once the Tube is put under vacuum, the atmospheric pressure on the non-Tube side of the seal forces the seal into contact with the Tube and effectively seals it until removed.

The Tube may be manufactured from a durable, heat-resistant, and airtight material such as glass, metal, plastic, or silicone. In addition, the Tube shape is designed to be the appropriate size and shape to hold rolls of varying sizes and is ergonomic for ease of use.

In this and other embodiments, the Activation Mechanism is further comprised of a button or switch for manual activation and may optionally include a timer or other automatic shut-off mechanism.

In this and other embodiments, the Power Source is further comprised of battery pack for power storage, a Charging Circuit that charges the battery and monitors charge levels, a Charging port for charging the Power Source, a Power Management Circuit that regulates the Power Supply for stable and efficient power provisioning, an Over-Voltage Protection Circuit that prevents the battery from overcharging, and a Low-Voltage Protection Circuit that prevents the battery from discharging below a set threshold.

The Charging port may be a USB port, AC adapter, or similar connection type. The Over-Voltage Protection Circuit and Low-Voltage Protection Circuit are designed to prevent damage to the Power Supply.

In this and other embodiments, the Control Circuit is further comprised of a Microcontroller that manages the overall operation of the device, a Power Management Unit that regulates the voltage and current, an Input/Output Interface that allows the control circuit to communicate with other components of the device, such as the activation mechanism and air suction unit, and a Power Indicator that provides visual or auditory feedback to the user to indicate the device's status.

In this and other embodiments, the Housing may be comprised of plastic, metal, or a combination of materials, so long as the material used for the housing is durable and able to withstand frequent use and handling. The shape of the housing should be ergonomic, comfortable to hold, and easy to grip. In addition, the Housing shape allows for easy access to the activation mechanism and power source. The housing also protects the internal components of the device from damage, including damage from particulates such as dust, moisture, or impacts. In addition, the housing may optionally include seals or gaskets to prevent air from escaping.

Aesthetically, the color and finish of the Housing should be appealing to the user and may include branding or labeling that clearly identifies the manufacturer and device model. The labeling may also include any necessary safety warnings or information.

In addition to extinguishing and saving rolls, the vacuum extinguisher may be used to vacuum save herbs or other organic products by placing the herbs inside the vacuum extinguisher and evacuating the air. By removing the oxygen from the device, it preserves the herbs contained within.

As another added benefit of the vacuum extinguisher design, once the air is evacuated from the device it acts as a smell proof container and eliminates the odors from anything kept inside.

In another embodiment the vacuum extinguisher is comprised of a housing with a first end and a second end with a hinge movably connected to the second end of the housing, a lid connected to the hinge, wherein the lid includes a recess operable to locate a stopper, a tube with a first end, a second end, an interior chamber, wherein the first end is sealed and the second end is open, and the tube is removably mounted inside the housing such that the lid covers the tube, wherein the stopper is operable to seal the tube second end, a pump attached to the housing that is operable to create a vacuum in the tube by removing air from the tube interior chamber, a battery operable to power the pump, a controller operable to allow charging of the battery and controlling the power supplied by the battery to the pump, a back cover that removably attaches to the housing such that an enclosed space is created between the housing and the back cover that encloses the pump, the battery, and the controller, and a button operable to activate and deactivate the pump.

In this and other embodiments, the controller is operable to vary charging speed based on battery charge level.

In this and other embodiments, a control circuit operable to vary vacuum generation speed may be included.

In this and other embodiments, a noise suppressor operable to reduce the noise generated by the pump may be included.

In this and other embodiments, the tube material is glass, aluminum, titanium, plastic, or ceramic.

In this and other embodiments, the seal material is rubber, Polytetrafluoroethylene, Fluorosilicone, Polyurethane, silicone, nitrile, or latex.

Using these embodiments, a method for operating a vacuum extinguisher may be performed as follows: opening a vacuum extinguisher; placing a roll into the vacuum extinguisher; closing the vacuum extinguisher; pressing the button to activate the pump, thereby removing air from the tube; and releasing the button once the air is removed.

In addition to the above functions as a roll extinguisher and roll storage device, the Vacuum Extinguisher may also be used to store any other item that fits inside it and is desirable to store in vacuum. Examples of things that can be stored are herbs and other plant products, chemicals or the like that are reactive with oxygen, or items for consumption.

In this and other embodiments, the glass tube and stopper are removable after vacuum sealing. Once removed, the glass tube may be replaced with another empty or filled glass tube. To accommodate the removable tubes, the stopper is removable with the glass tube. Alternatively, if removable glass tube are not required or used, the stopper may be fixedly attached to the lid.

The stopper may be attached the lid fixedly using screw threading or may be removably attached using a slide in connection.

As will be obvious to anyone of skill in the art, numerous modifications to the features described are possible. Accordingly, the described and illustrated embodiments are to be construed as merely exemplary of the inventive concepts expressed herein and addressed in the appended claims.

For a better understanding of the invention, its operating advantages and the specific objects attained by its uses, reference should be made to the accompanying drawings and descriptive matter in which there are illustrated preferred embodiments of the invention.

Various objects, features, aspects and advantages of the present embodiment will become more apparent from the following detailed description of embodiments of the design, along with the accompanying drawings.

### DESCRIPTION OF THE DRAWINGS

Note: The drawing and figures may be in simplified form and should not be considered to be precisely to scale.

FIG. 1 is an exploded view of one embodiment of the Vacuum Extinguisher.

FIG. 2 is side view of one embodiment of the Vacuum Extinguisher.

FIG. 3 is a front view of one embodiment of the Vacuum Extinguisher.

FIG. 4 is a cutaway view of one embodiment of the Vacuum Extinguisher.

FIG. 5 is a detail view of one embodiment of the Vacuum Extinguisher Seal.

FIG. 6 is a detail view of one embodiment of the Vacuum Extinguisher Seal under vacuum.

### DETAILED DESCRIPTION OF THE INVENTION

The present Vacuum Extinguisher greatly improves upon current designs in many ways. In the following description, numerous specific details are set forth to provide a more thorough description of embodiments of the Vacuum Extinguisher. It will be apparent, however, to one skilled in the art, that the embodiments of the Vacuum Extinguisher may be practiced without these specific details. In other instances, well-known features have not been described in detail so as not to obscure the many benefits of the Vacuum Extinguisher. In all instances, it should be expressly understood that the embodiments illustrated herein are merely exemplary of the inventive concepts expressed and that many alterations and modifications may be made by those having ordinary skill in the art without departing from the spirit and scope of the embodiments.

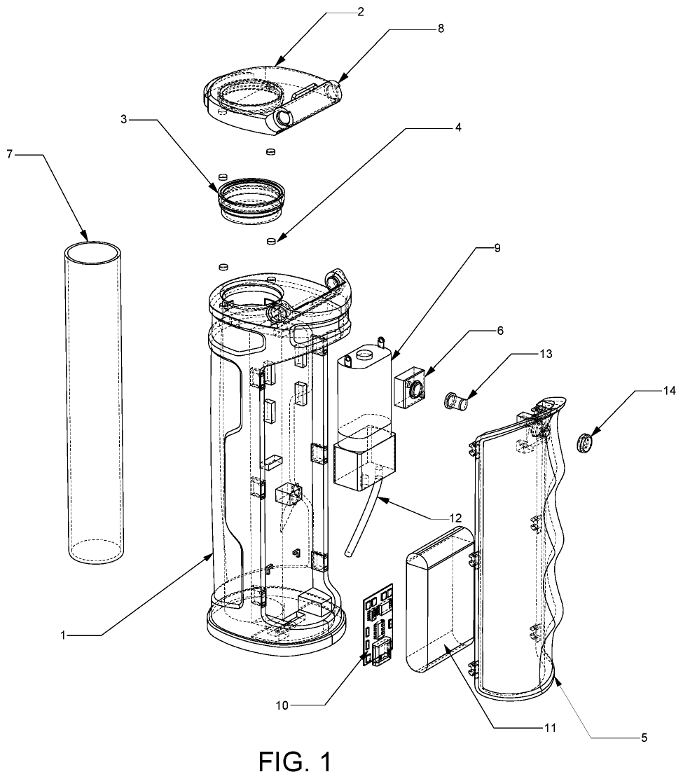

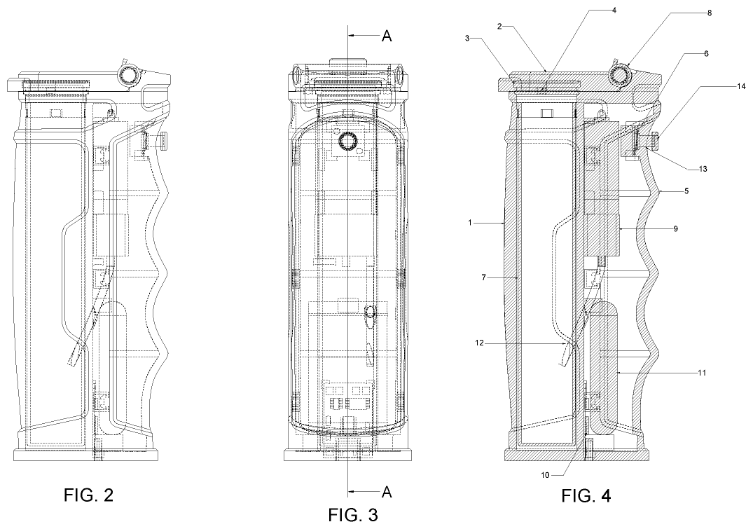

Referring now to FIGS. 1 to 4, which illustrate a vacuum extinguisher with a glass tube 7, housed in a body 1 which has a lid 2 attached via a hinge 8. The hinge 8 moves between an open and closed positions with magnets 4 holding the lid in the closed position unless opened by a user. A stopper 3 is attached to the underside of the hinge 8 and seals the glass tube 7 to make it airtight when the lid 2 is in the closed position. When the hinge 2 is in the open position, the glass tube 7 is accessible and the user may place or remove a roll from the glass tube 7. A vacuum pump 9 is mounted inside the body 1 and is connected to an Air Gap 15 via a vacuum tube 12. The vacuum pump is powered by a connected battery 11, and the power regulated by a controller 10. To activate the vacuum pump 9, the user presses a button assembly, which contains a button 6, a button spacer 13, and a button cap 14.

Once activated, the vacuum pump 9 removes air, and any other gases contained in the glass tube 7, from the glass tube 7. With the air removed from the glass tube 7, any combustion reactions occurring will be extinguished due to a lack of oxygen. By removing the oxygen, the vacuum extinguishes the roll and preserves it for later use by the user.

In this and other embodiments, a filter (not shown) may be used to filter the evacuated air, thereby preventing fumes and other noxious smells or chemicals from escaping.

In this and other embodiments, the controller 10 acts as a charger is also contained in the housing 1 and is connected to the battery 11 during operation 8 to allow it to charge.

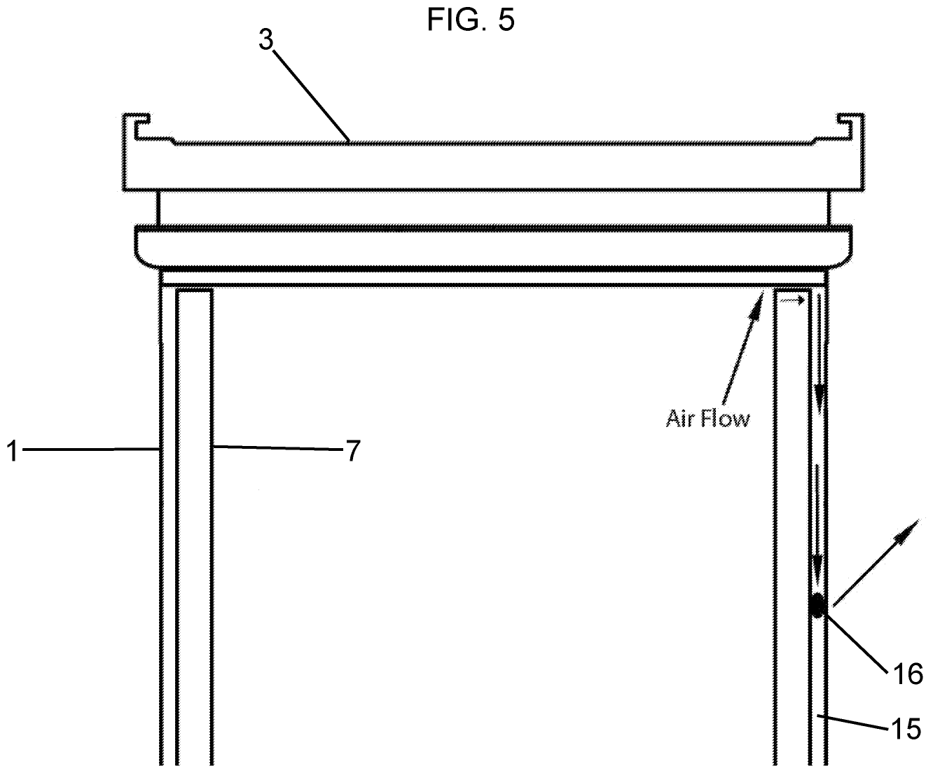

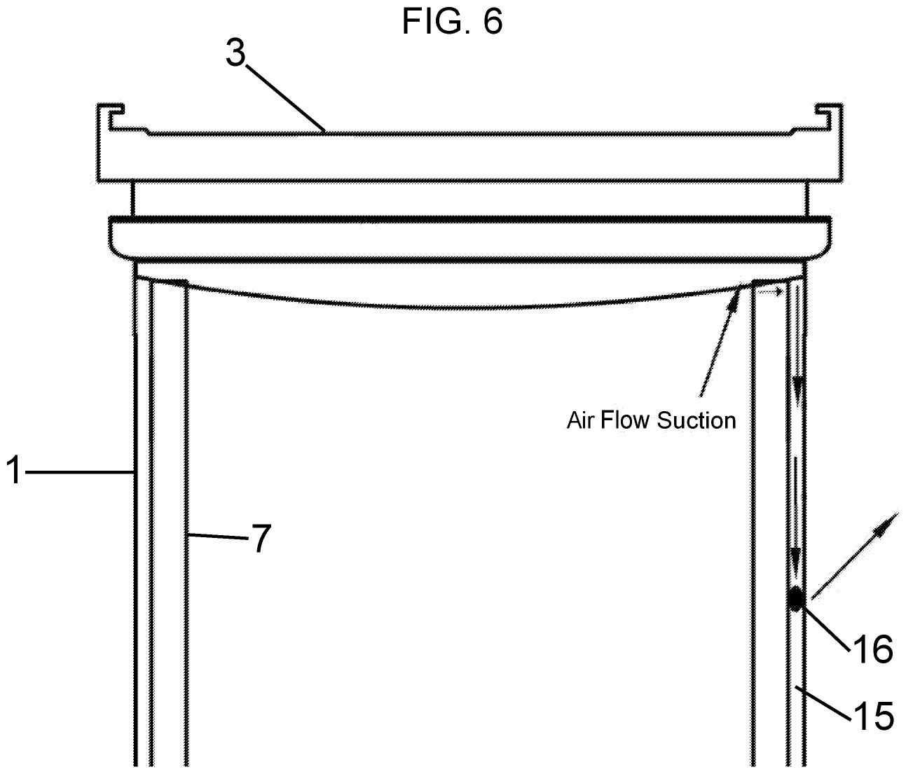

Turning now to FIG. 5, which shows the Vacuum Extinguisher Seal, the Seal 3 is shown without vacuum in the Glass Tube 7. An Air Gap 15 exists between the Housing 1 and the Glass Tube 7. The Air Gap 15 is connected to the vacuum tube 12 and allows the passage of air, or other gases, out of the Glass Tube 7 via an Access Port 16. Under normal pressures, the Seal 3 is not in contact with the Glass Tube 7 and this allows air to pass out of the interior of the Glass Tube 7. During operation, as shown in FIG. 6, the Seal 3 is made of a material that deflects due to atmospheric pressure on the seal face opposite the Glass Tube 7. Once the Glass Tube 7 is under vacuum, the Seal 3 deflects and comes into contact with the Glass Tube 7, thereby sealing the Glass Tube 7.

Numerous modifications to the features described and shown are possible. Accordingly, the described and illustrated embodiments are to be construed as merely exemplary of the inventive concepts expressed herein and addressed in the appended claims.

What is claimed is:

1. A Vacuum Extinguisher comprising:
a housing with a first end and a second end;
a hinge movably connected to said second end of said housing;
a lid connected to said hinge, wherein said lid includes a recess operable to locate a stopper;
a tube with a first end, a second end, an interior chamber, wherein said first end is sealed and said second end is open, and said tube is removably mounted inside said housing such that said lid covers said tube;
said stopper is operable to seal said tube second end;
a pump attached to said housing that is operable to create a vacuum in said tube by removing air from said tube interior chamber;
a battery operable to power said pump;
a controller operable to allow charging of said battery and controlling the power supplied by said battery to said pump;
a back cover that removably attaches to said housing such that an enclosed space is created between said housing and said back cover that encloses said pump, said battery, and said controller; and
a button operable to activate and deactivate said pump.

2. An apparatus according to claim 1, wherein said controller has an adaptive charger operable to vary charging speed based on battery charge level.

3. An apparatus according to claim 1, wherein said controller is operable to vary vacuum generation speed.

4. An apparatus according to claim 1, further comprising a noise suppressor operable to reduce the noise generated by said pump.

5. An apparatus according to claim 1, wherein said battery is a battery or capacitor.

6. An apparatus according to claim 1, wherein said tube material is glass, aluminum, titanium, plastic, or ceramic.

7. An apparatus according to claim 1, wherein said seal material is one of a group consisting of rubber, Polytetrafluoroethylene, Fluorosilicone, Polyurethane, silicone, nitrile, or latex.

8. A method for operating a vacuum extinguisher comprising:
opening a vacuum extinguisher;
placing an item into said vacuum extinguisher;
closing said vacuum extinguisher;
pressing said button to activate said pump, thereby removing air from said tube; and
releasing said button once said air is removed.

9. An apparatus according to claim 8, wherein said item is one of a group consisting of a roll, a cigar, an herb, a plant product, a plant seed, a spice, a chemical compound reactive with oxygen, a medicine, emergency supplies, artwork, collectibles, jewelry, or a perishable item.
